(19) United States
(12) Patent Application Publication
(10) Pub. No.: US 2007/0271580 A1
(43) Pub. Date: Nov. 22, 2007

(54) Methods, Apparatus and Computer Program Products for Audience-Adaptive Control of Content Presentation Based on Sensed Audience Demographics

(75) Inventors: Steven N. Tischer, Atlanta, GA (US); Robert A. Koch, Norcross, GA (US); Scott M. Frank, Dunwoody, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/549,698

(22) Filed: Oct. 16, 2006

Related U.S. Application Data
(60) Provisional application No. 60/801,237, filed on May 16, 2006.

(51) Int. Cl. H04N 7/10; H04N 7/025; G06F 13/00; H04N 5/445; G06F 3/00

(52) U.S. Cl. 725/35; 725/46; 725/34

(57) ABSTRACT

Content is presented by sensing attributes of unknown audience members and determining demographics of the unknown audience members from the attributes that are sensed. A content presentation device is controlled based on the demographics that are determined. Related methods, systems, and computer program products are disclosed.

### CROSS REFERENCE TO RELATED APPLICATION

This invention claims the benefit of and priority to provisional Application Ser. No. 60/801,237, filed May 16, 2006, entitled Methods, Systems and Computer Program Products For Life Activity Monitor, assigned to the assignee of the present application, the disclosure of which is hereby incorporated herein by reference in its entirety as if set forth fully herein.

### FIELD OF THE INVENTION

This invention relates to content presentation methods, apparatus and computer program products and, more particularly, to methods, apparatus and computer program products for controlling content presentation.

### BACKGROUND OF THE INVENTION

The evolution of cable, satellite, cellular wireless and other broadband communications technologies, along with the concurrent development of content presentation devices, such as digital TVs, satellite radios, audio players, digital video disc (DVD) players and other record/playback devices, has led to an explosion in the volume and variety of content available to consumers. For example, digital cable and satellite television services now typically offer hundreds of different channels from which to choose, including general interest channels that offer a variety of different types of content along lines similar to traditional broadcast stations, as well as specialized channels that provide more narrowly focused entertainment, such as channels directed to particular interests, such as particular sports, classic movies, shopping, children's programming, and the like.

As the sources and types of content proliferate, the task of finding and selecting desirable or appropriate content for an audience may become problematic. In particular, choosing appropriate content for a group typically involves an ad hoc manual selection of programming, which may be supplemented by programming guides and other aids. The task of programming selection may be complicated due to the sheer volume of available content, the variety of different rating systems employed for different types of content, and by the increasingly ready availability of unregulated programming, such as programming with strong sexual content, violence and/or strong language, which may be inappropriate for some users.

Moreover, with the increased availability of large screen, flat panel televisions and monitors, the continuous presentation of content has become ubiquitous in public venues, such as airports, hotels, building lobbies, restaurants, clubs, bars and/or other entertainment venues, and in media rooms and/or other locations in private homes. In any of these environments, it may be increasingly problematic to select desirable or appropriate content for an audience.

An audience measurement system and method is described in U.S. Pat. No. 5,771,307 to Lu et al., entitled Audience Measurement System and Method. As stated in the Abstract of this patent, in a passive identification apparatus for identifying a predetermined individual member of a television viewing audience in a monitored viewing area, a video image of a monitored viewing area is captured. A template matching score is provided for an object in the video image. An Eigenface recognition score is provided for an object in the video image. These scores may be provided by comparing objects in the video image to reference files. The template matching score and the Eigenface recognition score are fused to form a composite identification record from which a viewer may be identified. Body shape matching, viewer tracking, viewer sensing, and/or historical data may be used to assist in viewer identification. The reference files may be updated as recognition scores decline.

User attention-based adaptation of quality level is described in U.S. Patent Application Publication 2003/0052911 to Cohen-solal, entitled User Attention-Based Adaptation of Quality Level To Improve the Management of Real-Time Multi-Media Content Delivery and Distribution. As stated in the Abstract of this patent application publication, a method for transmitting a stream of multi-media content from provider server to a user device includes transmitting multi-media content from the provider server to the user device via a communication network and outputting the multi-media content from the user device to a user via an output on the user device such that the multi-media content is delivered from the provider server to the user in real-time. A degree of attention that the user directs to the output of the user device is continuously determined during the transmission and a parameter adjusting module at the provider server adjusts a parameter of the multi-media content in response to the degree of attention.

### SUMMARY OF THE INVENTION

Embodiments of the present invention provide methods, apparatus and/or computer program products for controlling presentation of content. In some embodiments, attributes of a plurality of unknown audience members are sensed. Demographics of the plurality of unknown audience members are then determined from the attributes that are sensed. A content presentation device is then controlled based on the demographics that are determined.

In some embodiments, sensing of audience attributes may be repeatedly performed, and determining demographics of the plurality of unknown audience members may also be repeatedly performed with increasing levels of confidence in response to the repeated attribute sensing. The content presentation device may be repeatedly controlled in response to the increasing levels of confidence. In other embodiments, sensing of attributes is repeatedly performed, and changes in the demographics of unknown audience members may be determined in response to the repeated sensing, such that the content presentation device may be repeatedly controlled in response to the changes in the demographics. In yet other embodiments, the addition or loss of at least one of the unknown audience members may also be detected. Sensing of audience attributes, determining demographics and controlling the content presentation device may again be performed in response to detecting the addition or loss of at least one of the unknown audience members. In still other embodiments, the attributes that are sensed are time-stamped, and the demographics are determined over time from the time-stamped attributes that are sensed. The content presentation device is controlled based on a current time and the demographics that are determined.

Embodiments of the present invention that were described above may determine demographics and control a content presentation device without affirmatively identifying the unknown audience members. In other embodiments of the invention, the demographics of at least one audience member may be determined in response to information provided by the at least one audience member. In these embodiments, the content presentation device may be controlled in response to the demographics that were determined by sensing attributes and from the information that was provided by the at least one audience member. The information provided by the at least one audience member may comprise demographic information for the at least one audience member and/or an identification of the at least one audience member. Different weight may be applied to the information provided and the attributes that are sensed.

Sensing attributes of a plurality of unknown audience members may be accomplished in many ways according to various embodiments of the present invention. For example, multiple sensors of the same and/or different types may be used to sense attributes. The multiple sensors may comprise at least one image sensor, audio sensor and/or olfactory sensor and the corresponding attributes may comprise at least an image, sound and/or smell of the unknown audience members. Moreover, many different demographic determinations may be obtained, including gender, age, nationality, language, physical activity, attentiveness and/or intoxication demographics of the plurality of audience members. Moreover, many ways of controlling a content presentation device based on demographics that are determined may be provided according to various embodiments of the present invention. For example, a type (genre) of content presented on the content presentation device, a language of the content, a version of the content (e.g., content rating), a sound volume of the content and/or selection of advertising content may be controlled based on the demographics that are determined.

In some specific embodiments, sensing attributes of a plurality of unknown audience members may be provided by sensing an image of the audience members. Demographics may be determined by determining a predominant gender and a predominant nationality of the audience members from the image. The content presentation device may then be controlled to provide content that is directed to the predominant gender and the predominant nationality, and in a language of the predominant nationality. In other embodiments, audio may be sensed from the audience members, and a predominant gender and/or predominant nationality of the audience members may be determined from the audio. These embodiments also may be combined using image and audio sensing.

In yet other embodiments, motion of the audience members may be sensed and an activity level demographic of the audience may be determined from the motion. The content presentation device may be controlled to present content that is directed to the activity level of the audience. Many other embodiments can be provided.

Further embodiments of the present invention provide content presentation systems including a content presentation device configured to provide an audio and/or visual output, and an audience-adaptive controller that is configured to sense attributes of a plurality of unknown audience members, determine demographics of the plurality of unknown audience members from the attributes that are sensed, and control the content presentation device based on the demographics that are determined. The audience-adaptive controller may operate according to any of the above-described embodiments.

Additional embodiments of the present invention provide computer program products for controlling a content presentation device. These computer program products include computer program code embodied in a storage medium, the computer program code including program code configured to sense attributes of a plurality of unknown audience members, to determine demographics of the plurality of unknown audience members from the attributes that are sensed and to control the content presentation device based on the demographics that are determined. Computer program products according to any of the above-described embodiments may be provided.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram of content presentation apparatus, methods and/or computer program products according to some embodiments of the present invention.

FIGS. 2-6 are flowcharts illustrating operations for controlling content presentation according to some embodiments of the present invention.

FIG. 7 illustrates a demographics database according to some embodiments of the present invention.

FIG. 8 illustrates a rules database according to some embodiments of the present invention.

FIG. 9 graphically illustrates a changing demographic over time according to some embodiments of the present invention.

FIG. 10 graphically illustrates changing confidence levels of a demographic over time according to some embodiments of the present invention.

FIGS. 11-14 are flowcharts illustrating operations for controlling content presentation according to other embodiments of the present invention.

FIG. 15 graphically illustrates changing attentiveness levels of an audience member over time.

FIG. 16 graphically illustrates correlating audience member attentiveness with content characteristics according to some embodiments of the present invention.

FIG. 17 illustrates presenting a metric of attentiveness according to some embodiments of the present invention.

FIG. 18 is a flowchart of operations that may be performed to control content presentation according to still other embodiments of the present invention.

FIG. 19 schematically illustrates determining attentiveness as a function of position according to some embodiments of the present invention.

FIGS. 20 and 21 are flowcharts illustrating operations for controlling content presentation according to still other embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element, it can be directly responsive to the other element, or intervening elements may be present. In contrast, when an element is referred to as being “directly responsive” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Some embodiments of the present invention may arise from recognition that in some public or private venues, it may be difficult, impossible and/or undesirable to identify individual members of an audience. Nonetheless, content presentation to the audience may still be controlled by sensing attributes of a plurality of unknown audience members and determining demographics of the plurality of unknown audience members from the attributes that are sensed.

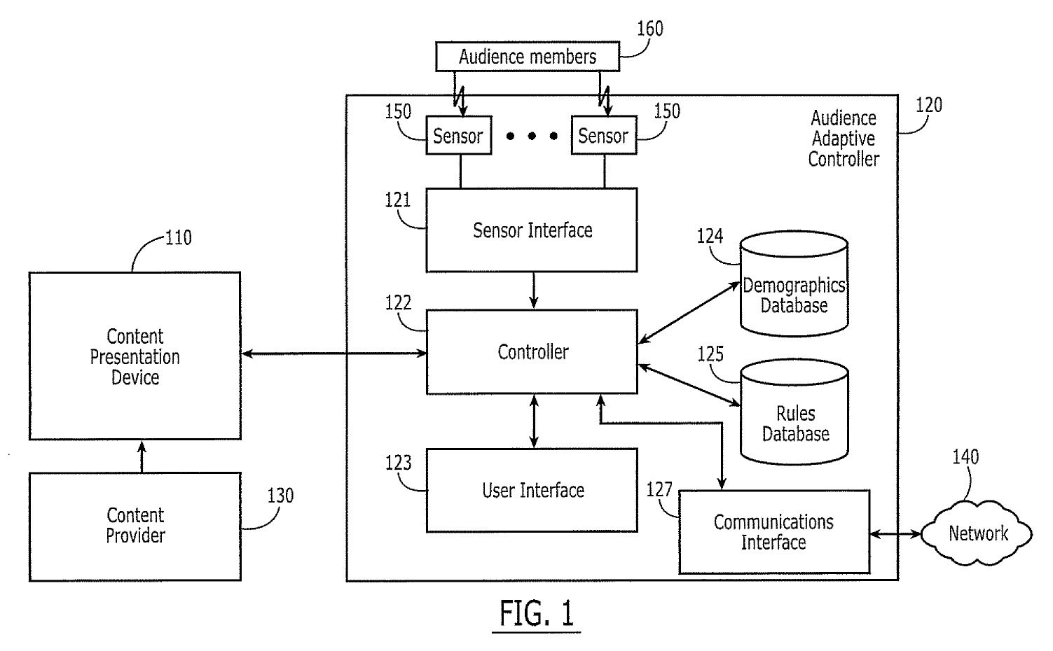

FIG. 1 is a block diagram of content presentation apparatus (systems), methods and/or computer program products and operations thereof, according to some embodiments of the present invention. A content presentation device 110 is controlled by an audience-adaptive controller 120. As used herein, a “content presentation device” may comprise any device operative to provide audio and/or visual content to an audience, including, but not limited to, televisions, home theater systems, audio systems (stereo systems, satellite radios, etc.), audio/video playback devices (DVD, tape, DVR, TiVo®, etc.), internet and wireless video devices, set-top boxes, and the like. The content presentation device 110 may, for example, be a device configured to receive content from a content provider 130, such as a subscription service, pay-per-view service, broadcast station and/or other content source and/or may be configured to present locally stored content. As used herein, “content” includes program content and/or advertising content.

As shown in FIG. 1, the audience-adaptive controller 120 includes a sensor interface 121 that is configured to sense attributes of a plurality of unknown audience members 160 via one or more sensors 150. As used herein, an “attribute” denotes any characteristic or property of the audience members. The sensors 150 may include one or more image sensors, audio sensors, olfactory sensors, biometric sensors (e.g., retina sensors), motion detectors and/or proximity detectors. The sensors 150 can be separate from the audience-adaptive controller 120 and/or integrated at least partially therewith. Moreover, the sensors may be centralized and/or dispersed throughout the environment and/or may even be located on the audience members 160. The sensor interface 121 processes the sensor data to provide, for example, face recognition, voice recognition, speech-to-text conversion, smell identification, etc.

More specifically, the sensors 150 may include imaging sensors, audio sensors, contact sensors and/or environment sensors, and the sensor data may be converted from an analog to a digital signal and stored. The sensor interface 121 may include one or more analysis engines, such as gait analysis, face recognition or retinal comparators that are responsive to the data from the imaging sensors; voice recognition, voice analysis, anger detection and/or other analysis engines that are responsive to the audio sensors; and/or biometric analysis sensors that are responsive to environmental sensors, contact sensors, the imaging sensors and/or the audio sensors.

Still referring to FIG. 1, a presentation device controller 122 is responsive to the sensor interface 121, to determine demographics of the plurality of unknown audience members 160 from the attributes that are sensed by the sensors 150 via the sensor interface 121, and to store the demographics into a demographics database 124. As used herein, “demographics” denote common characteristics or properties of the audience. The presentation device controller 122 is also configured to control the content presentation device 110, responsive to the demographics in the demographics database 124, and responsive to rules, algorithms and/or other logic that may be stored in a rules database 125. It will be understood by those having skill in the art that the rules database 125 may be implemented using a set of rules, algorithms, Boolean logic, fuzzy logic and/or any other commonly used techniques, and may include expert systems, artificial intelligence or more basic techniques.

The presentation device controller 122 may also be configured to interoperate with a communications interface 127, for example a network interface that may be used to communicate messages, such as text and/or control messages to and/or from a remote user over an external network 140. As also illustrated, the presentation device controller 122 may be further configured to interact with user interface circuitry 123, for example input and/or output devices that may be used to accept control inputs from a user, such as user inputs that enable and/or override control actions by the presentation device controller 122.

It will be understood that content presentation systems, methods and/or computer program products of FIG. 1 may be implemented in a number of different ways. For example, the content presentation device 110 may include any of a number of different types of devices that are configured to present audio and/or visual content to an audience. The audience-adaptive controller 120 may be integrated with the content presentation device 110 and/or may be a separate device configured to communicate with the content presentation device 110 via a communications media using, for example, wireline, optical and/or wireless signaling.

In general, the audience-adaptive controller 120 may be implemented using analog and/or digital hardware and/or combinations of hardware and software. The presentation device controller 122 may, for example, be implemented using a microprocessor, microcontroller, digital signal processor (DSP) or other computing device that is configured to execute program code such that the computing device is configured to interoperate with the content presentation device 110, the sensor interface 121 and the user interface 123. The demographics database 124 and the rules database 125 may, for example, be magnetic, optical, solid state or other storage medium configured to store data under control of such a computing device. The sensor interface 121 may utilize any of a number of different techniques to process sensor data, including, but not limited to, image/voice processing techniques, biometric detection techniques (e.g., voice, retina, facial recognition, etc.), motion detection techniques, and/or proximity detection techniques.

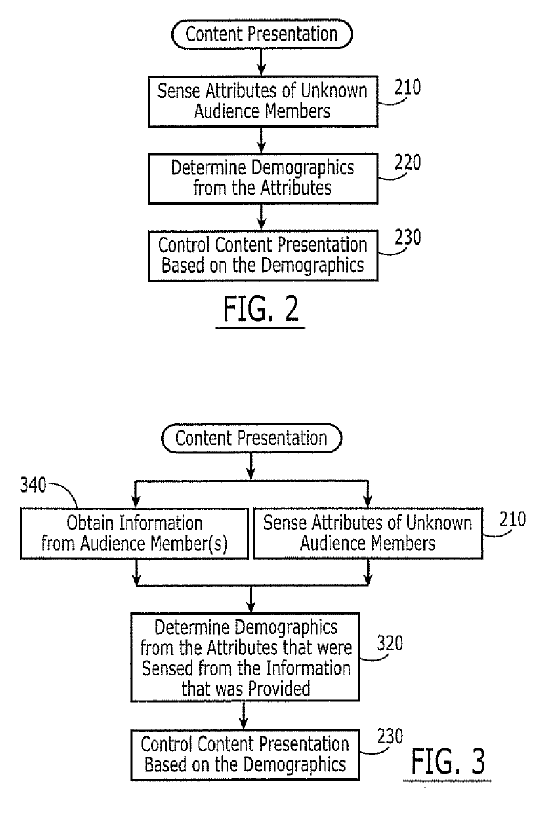

FIG. 2 is a flowchart of operations that may be performed to present content according to various embodiments of the present invention. These operations may be carried out by content presentation systems, methods and/or computer program products of FIG. 1.

Referring to FIG. 2, at Block 210, attributes of a plurality of unknown audience members are sensed. Operations of Block 210 may be performed using the sensors 150 and sensor interface 121 of FIG. 1 to sense attributes of a plurality of unknown audience members 160. Then, at Block 220, demographics of the plurality of unknown audience members are determined from the attributes that are sensed. The demographics may be determined by, for example, the controller 122 of FIG. 1, and stored in the demographics database 124 of FIG. 1. Finally, at Block 230, a content presentation device, such as the content presentation device 110 of FIG. 1, is controlled, based on the demographics that are determined. For example, a rules database 125 may be used by the controller 122 in conjunction with the demographics that were stored in the demographics database 124, to control content that is presented in the content presentation device 110.

In some embodiments of FIG. 2, the operations of sensing attributes (Block 210), determining demographics information (Block 220) and controlling content presentation based on the demographics (Block 230) may be performed without affirmatively identifying any of the audience members. Accordingly, some embodiments of the present invention may control a content presentation device based on the demographics of the unknown audience members without raising privacy issues or other similar concerns that may arise if an affirmative identification is made. Moreover, in many public or private venues, affirmative identification may be difficult or even impossible. Yet, embodiments of the present invention can provide audience-adaptive control of content presentation using demographic information that is determined, without the need to affirmatively identify the audience members themselves.

Other embodiments of the invention, as illustrated in FIG. 3, may couple passive determination of demographics with information that is actively provided by at least one audience member. In particular, referring to FIG. 3, content is presented by obtaining information from at least one audience member at Block 340. The information provided by the at least one audience member at Block 340 may be combined with the attributes that are sensed at Block 210, to determine demographics from the attributes that were sensed and from the information that was provided by the at least one audience member. The content presentation device is then controlled at Block 230 based on the demographics.

The information that was provided by the at least one audience member at Block 340 may be demographic information that is provided by the at least one audience member. For example, at least one audience member may log into the system using, for example, a user interface 123 of FIG. 1, and indicate the audience member's gender, age, nationality, preferences and/or other information. In other embodiments, the at least one audience member may identify himself/herself by name, social security number, credit card number, etc., and demographic information for this audience member may be obtained based on this identification.

Moreover, the information that is obtained from the audience members at Block 340 may be weighted equally with the attributes that are sensed at Block 210, in some embodiments. However, in other embodiments, the information that is obtained from an audience member at Block 340 may be given a different weight, such as a greater weight, than the sensed attributes at Block 210. For example, an audience member who supplies information at Block 340 may have a heightened interest in the content that is displayed on the content presentation system. This audience member's demographics may, therefore, be given greater weight than the unknown audience members. For example, in a restaurant, the head of a family may provide information because the head of the family has more interest in the content presentation. Similarly, in a home multimedia system, the residents of the home may be given more weight in controlling the content presentation device than unknown guests. Conversely, a guest may be given more weight than a resident.

In still other embodiments, the information that is obtained from an audience member at Block 340 and/or the passively sensed information at Block 210, may be used to affirmatively identify an audience member, and a stored profile for the identified audience member may be used to control content, as described, for example, in copending application Ser. No. 11/465,235, to Smith et al., entitled Apparatus, Methods and Computer Program Products for Audience-Adaptive Control of Content Presentation, filed Aug. 17, 2006, assigned to the assignee of the present invention, the disclosure of which is hereby incorporated herein by reference in its entirety as if set forth fully herein. Combinations of specific profiles and demographics also may be used.

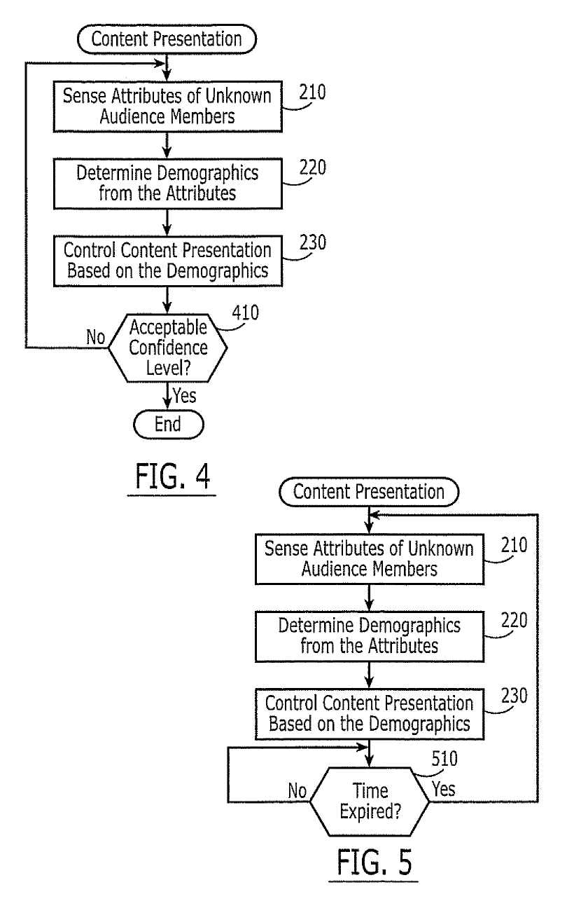

Embodiments of the present invention that were described in connection with FIGS. 2 and 3 can provide a single pass of presenting content. However, other embodiments of the present invention may repeatedly sense attributes, determine demographics from the attributes and control content based on the demographics, as will now be described in connection with FIGS. 4-6.

In particular, referring to FIG. 4, after the content presentation is initially controlled at Block 230 based on the demographics that were initially determined, a determination is made at Block 410 as to whether an acceptable confidence level in the accuracy of the demographics is obtained. For example, initially, the predominant gender of the unknown audience members may be determined at Block 210 and 220, but the predominant nationality of the unknown audience members may not yet be known. Accordingly, the confidence level in the demographics may be relatively low at Block 410, and sensor attributes may continue to be sensed and processed at Blocks 210 and 230, until additional desirable demographic information, such as predominant nationality and/or predominant age group, are known. Once the confidence level reaches an acceptable level at Block 410, additional control of the content presentation may not need to be provided. Accordingly, FIG. 4 illustrates embodiments of the present invention, wherein sensing attributes is repeatedly performed, wherein determining demographics of the plurality of unknown audience members is repeatedly performed with increasing levels of confidence in response to the repeated sensing, and wherein controlling a content presentation device is repeatedly performed in response to the increasing levels of confidence.

In some embodiments, the increasing confidence levels of FIG. 4 may be obtained as additional inputs are provided from additional types of sensors and/or as additional processing is obtained for information that is sensed from a given sensor. For example, initially, a motion detector may be able to sense that audience members are present and/or a number of audience members who are present, to provide rudimentary demographics. Content may be controlled based on these rudimentary demographics. Image processing software may then operate on the image sensor data using face recognition and/or body type recognition algorithms to determine the predominant gender of the audience. Voice recognition software may also operate concurrently to determine a predominant gender, thereby increasing the confidence level of the demographics. Content may then be controlled based on the predominant gender.

Further voice recognition and face recognition processing may actually be able to detect the predominant age of the audience and/or an age distribution, and the content may be further controlled based on this added demographic. Further processing by face recognition and/or voice recognition software may determine a predominant nationality and/or predominant language of the audience, and content may again be controlled based on the predominant nationality or language. Accordingly, increasing confidence levels in the demographics and/or increasing knowledge of the demographics over time may be accommodated.

For example, FIG. 10 graphically illustrates increasing confidence level over time for a given demographic, such as female children. At time T₁, a gait sensor may sense that children are involved. At a later time T₂, an image sensor may also detect that children may be present, and at a later time T₃, a voice processing may detect that girls are present, at a confidence level that exceeds a threshold T. The content may be controlled different at times T₁, T₂ and T₃, based upon the confidence level of the given demographic. These varying confidence levels may also be used to positively identify a given audience member, if desired, for example by initially sensing an image, correlating with a voice, correlating with a preferred position in the audience of that individual and then verifying by a prompt on the content presentation device, which asks the individual to confirm that he is, in fact, the identified individual. Accordingly, if it is desired to identify a given audience member, varying levels of confidence may be used, coupled with a prompt and feedback acknowledgement by the audience member.

FIG. 5 illustrates other embodiments of the present invention, wherein sensing attributes, determining demographics, and controlling the content presentation device (Blocks 210, 220 and 230, respectively) are repeatedly performed at periodic or non-periodic time intervals that are determined by expiration of a timer at Block 510. Thus, even when acceptable confidence as to the demographics is obtained, the demographics may be rechecked to update the demographics.

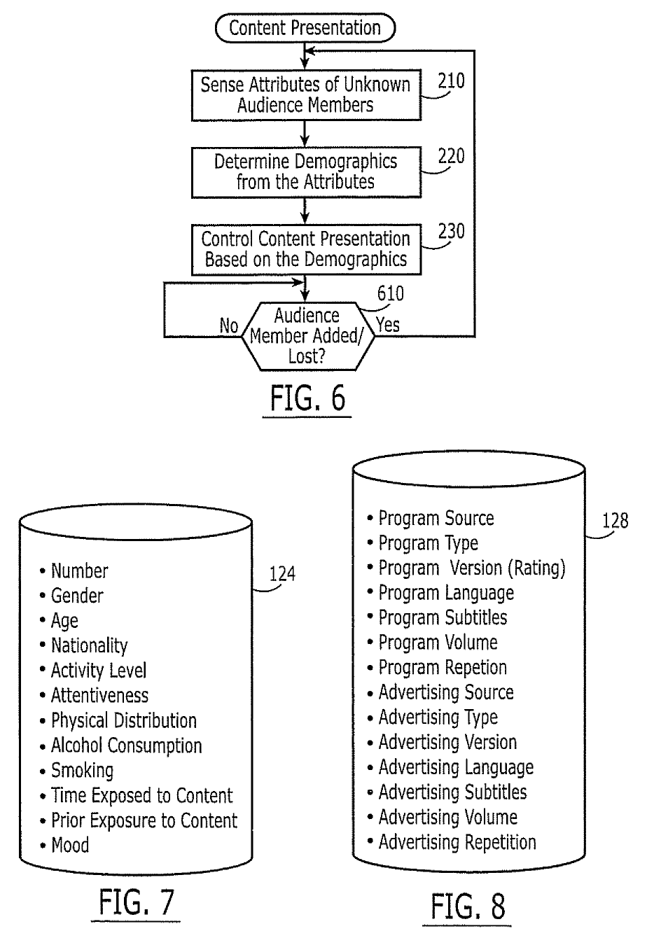

In embodiments of FIG. 5, the demographics are updated periodically, at fixed and/or variable time intervals. In contrast, in embodiments of FIG. 6, the operations of Blocks 210, 220 and 230 are repeated upon detecting addition or loss of at least one of the unknown audience members at Block 610. Thus, for example, image sensors may detect the addition or loss of at least one of the unknown audience members, and the operations of Blocks 210-230 are performed again to update the demographics.

As was described above, according to some embodiments of the invention, sensing attributes, determining demographics and controlling a content presentation device may be performed without affirmatively identifying the unknown audience members. According to other embodiments of the invention, even though the unknown audience members are not affirmatively identified, they can be tracked for their presence or absence. Thus, for example, in a home or a club, the presence of residents/club members and guests may be tracked separately, and the content presentation device may be controlled differently, depending upon demographics of the residents/club members and demographics of the guests who are present in the audience. Moreover, “guests” who have not been previously sensed, may be tracked differently, to ensure that the “guest” is not an intruder, pickpocket or other undesirable member of the audience. Accordingly, some embodiments of the present invention may also provide input to a security application that flags a previously undetected audience member as a potential security risk, even though the audience member is not actually identified.

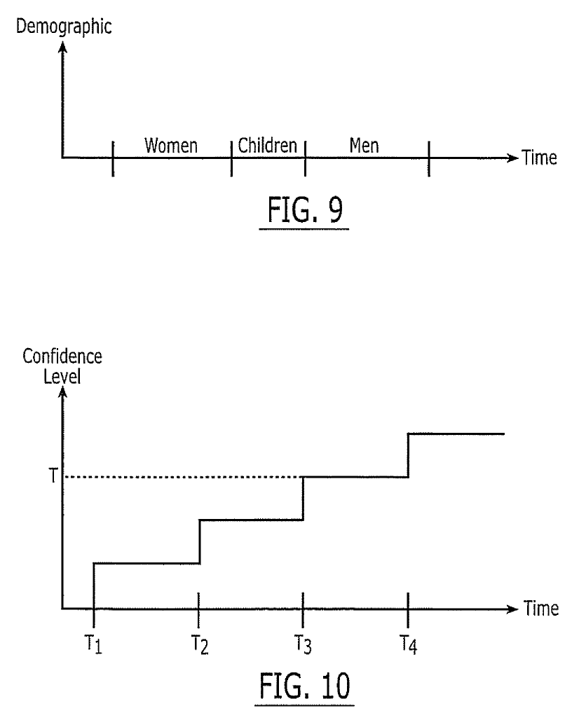

The demographics that are determined according to various embodiments of the invention may also be time-stamped, as illustrated in FIG. 9. For example, as shown in FIG. 9, over a given course of a day, the audience demographic that is interacting with a content presentation device, such as a home media system, may change from women early in the day, to children in the early afternoon and to men in the evening. By time-stamping the sensed attributes and determining demographic changes over time, the content presentation device may be controlled even in the absence of a current demographic, based on the time-stamped demographic of the audience and the current time. For example, in the demographic of FIG. 9, R-rated programming may be prohibited in the early afternoon. Moreover, as was described above, the various demographics may be determined at a varying confidence level over time, and the content presentation device may be controlled based on the demographics and the confidence level.

It will be understood by those having skill in the art that operations of FIGS. 4-6 may also be performed for embodiments of FIG. 3. Moreover, embodiments of FIGS. 2-6 may be combined in various combinations and subcombinations.

FIG. 7 illustrates demographic data that may be stored in a demographics database, such as demographics database 124 of FIG. 1. Demographic data may be obtained by sensing attributes of a plurality of unknown audience members and processing these attributes. Information provided by at least one audience member also may be used. In particular, as is well known to those having skill in the art, demographics indicates common characteristics or properties that define a particular group of people, here an audience. As used herein, demographics can include commonly used characteristics, such as age, gender, race, nationality, etc., but may also include other demographic categories that may be particularly useful for controlling a content presentation device. FIG. 7 illustrates representative demographics that may be used to control a content presentation device according to some embodiments of the present invention. In other embodiments, combinations and subcombinations of these and/or other demographic categories may be used. Each of the demographic categories illustrated in FIG. 7 will now be described in detail.

One demographic category can be the number of people in an audience that can be detected by image recognition sensors, proximity sensors, motion sensors and/or voice sensors. The content may be controlled, for example, by increasing the volume level in proportion to the number of people in the audience. Gender characteristics may also be used to control content. For example, content may be controlled based on whether the audience is predominantly male, predominantly female, or mixed.

Age also may be used to control the content. Image processing and/or voice processing may be used to determine an average age and/or an age distribution. Content may be controlled based on the average age and/or the age distribution. Special rules also may be applied, for example, when children are detected in the audience, or when seniors are detected in the audience.

Nationality may be determined by, for example, image processing and/or voice processing. Language and/or subtitles may be controlled in response to nationality. The content type (genre) also may be controlled. An activity level may be determined by, for example, image processing to detect motion and/or by using separate motion sensors. Activity level also may be determined by detecting the number of simultaneous conversations that are taking place. Content may be controlled based on activity level by, for example, increasing the brightness of the video and/or the volume of the audio to attract more of the audience members. More complex/subtle control of content may also be provided based on activity level.

Attentiveness may be determined, for example, by image analysis to detect whether eyes are closed and/or using other techniques that are described in greater detail below. Content may be controlled based on attentiveness by, for example, increasing the brightness of the video and/or the volume of the audio to attract more of the audience members. More complex/subtle control of content may also be provided based on attentiveness.

The physical distribution of the audience may be determined by, for example, image analysis, motion sensors, proximity detectors and/or other similar types of sensors. The content may be controlled based on whether the audience is tightly packed or widely dispersed. Alcohol consumption and/or smoking may be determined by, for example, chemical sensors and/or image analysis. Advertising content may be controlled in response to alcohol/smoking by the audience.

The time exposed to content may be determined by image analysis and time stamping of demographic information that identifies a time that an audience member is exposed to given content. The content may be varied to avoid repetition or to provide repetition, depending on the circumstances.

Prior exposure to the content can identify that a particular audience member has already been exposed to the content, by correlating the presence of an audience member who has not been actively identified, but whose presence has been detected. The content may be varied to avoid repetition or to provide repetition, depending on the circumstances. Moreover, exposure of given audience members or of the audience as a whole may be determined and used to control content presentation.

Finally, mood can be determined, for example, by analyzing biometric data, such as retinal data, analyzing the image and/or analyzing the interaction of the audience members. The content can be controlled to suit the audience mood and/or try change the audience mood.

In particular, in some embodiments, content presentation may be used as a mechanism to control an audience. For example, the content presentation device may be controlled to attempt to disperse the audience, to try to bring the audience closer together, to cause the audience to quiet down, or to try to cause the audience to have a higher level of activity. A feedback mechanism may be provided, using the sensors to measure the effectiveness of the audience control, and to further control the content presentation device based on this feedback mechanism.

It will be understood by those having skill in the art that FIG. 7 provides twelve examples of demographic data that can be determined from the attributes that are sensed according to various embodiments of the present invention, and that may be stored in demographic database 124. Various combinations and subcombinations of these demographics and/or other demographics may be determined and used to control the content presentation device according to other embodiments of the present invention.

It will also be understood that embodiments of the invention have generally been described above in terms of predominant demographics. However, other embodiments of the invention can divide demographics into various subgroups and control a content presentation device based on the various demographic subgroups that were determined. For example, the content presentation device may be controlled based on an average age that is determined and/or based on a number of audience members who are in a given age bracket. Similarly, content may be controlled based on a predominant nationality or based on a weighting of all of the nationalities that have been identified. Moreover, the various demographics may be combined using equal or unequal weightings, so that certain demographics may predominate over others. Thus, for example, if children are identified in the audience, the version (e.g., rating) of the programming may be controlled, even though a far larger majority of the audience is adult males.

Various aspects of controlling the content presentation device, according to various embodiments of the present invention, will now be described. These control parameters may be stored in the rules database 125 of FIG. 1. In particular, referring to FIG. 8, a program source, such as broadcast or taped, a program type, such as sports, news, movies and/or a program version, such as R-rated, PG-rated or G-rated, may be controlled. The program language may be controlled, and the provision of subtitles in a program may also be controlled. The program volume and/or other audio characteristics, such as audio compression, may be controlled. The repetition rate of a given program also may be controlled. Similar control of advertising content may also be provided.

### EXAMPLES

The following examples shall be regarded as merely illustrative and shall not be construed as limiting the invention.

Each of the following examples will describe various rules that may be applied to various demographics of FIG. 7, to provide control of the content presentation device as was illustrated in FIG. 8. Each of these examples will be described in terms of IF-THEN statements, wherein the “IF” part of the statement defines the demographics of the unknown audience members (Block 220 of FIG. 2), and the “THEN” part of the statement defines the control of the content presentation device (Block 230 of FIG. 2). These IF-THEN statements, or equivalents thereto, may be stored in the rules database 125 of FIG. 1. The IF-THEN statement of each example will be followed by a comment.
1. IF Number<X, THEN Program Source=Broadcast AND Program Type=News. Comment: Default content for small audiences.
2. IF Gender=mixed, THEN Program Type=Movie AND Program Version ═PG. Comment: Content not geared to men or women.
3. IF Gender=male, THEN Program Type=Sports AND Program Volume=Loud. Comment: Male-centered content.
4. IF Gender=female, THEN Program Type=Women AND Program Volume=Soft. Comment: Female-centered content.
5. IF Average Age<12, THEN Program Version=G. Comment: Children-centered content.
6. IF Average Age>21, THEN Program Version=R. Comment: Adult-centered content.
7. IF Average Age>21 AND at least one member<12, THEN Program Version=G. Comment: Minority demographic controls content.
8. IF Predominant Nationality=American, THEN Program Language English AND Subtitles=Spanish. Comment: Default for USA.
9. IF Predominant Nationality=Japanese, THEN Program Language=Japanese AND Subtitles English. Comment: Default for Japanese venue in USA.
10. IF Activity Level=high, THEN Program Type=Action. Comment: Content corresponds to activity level.
11. IF Activity Level=high AND Physical Distribution=Wide, THEN Program Type=Music. Comment: Background content, audience not actively watching/listening.
12. IF Activity Level=high AND Physical Distribution Wide, THEN Program Type=News AND Volume=Muted. Comment: Background content, audience not actively watching/listening.
13. IF Alcohol Consumption=High AND Smoking=High AND Time Early AM, THEN Program Type=News AND Volume=Low. Comment: Control content to disperse the audience.
14. IF Alcohol Consumption=Low AND Smoking=Low AND Time=Late PM, THEN Program Type=Movie AND Program Version=R AND Volume Loud. Comment: Control content to increase tobacco/alcohol use.
15. IF Nationality=German AND Activity Level=Low AND Physical Distribution=Narrow, THEN Program Source=Flight Schedule AND Program Language=German AND Program Subtitles=English. Comment: Presenting content on airport TV screen near departure gate.
16. IF Time Exposed to Content=Low, THEN Repeat Previous Program or Advertisement. Comment: Repeat content for higher exposure.

Various combinations of these and/or other rules may be provided. For example, in some embodiments of the present invention, a predominant gender and a predominant nationality of the audience members may be determined from an image and the content presentation device is controlled to present content that is directed to the predominant gender and the predominant nationality in a language of the predominant nationality. In other embodiments, the predominant gender and predominant nationality may be sensed using an image of the audience members and/or audio from the audience members.

FIG. 7 described attentiveness as one demographic category that may be stored in a demographics database, and may be used to control content presentation. Many other embodiments of the invention may use attentiveness to control content presentation in many other ways, as will now be described. As used here, “attentiveness” denotes an amount of concentration on the content of the content presentation device by one or more audience members.

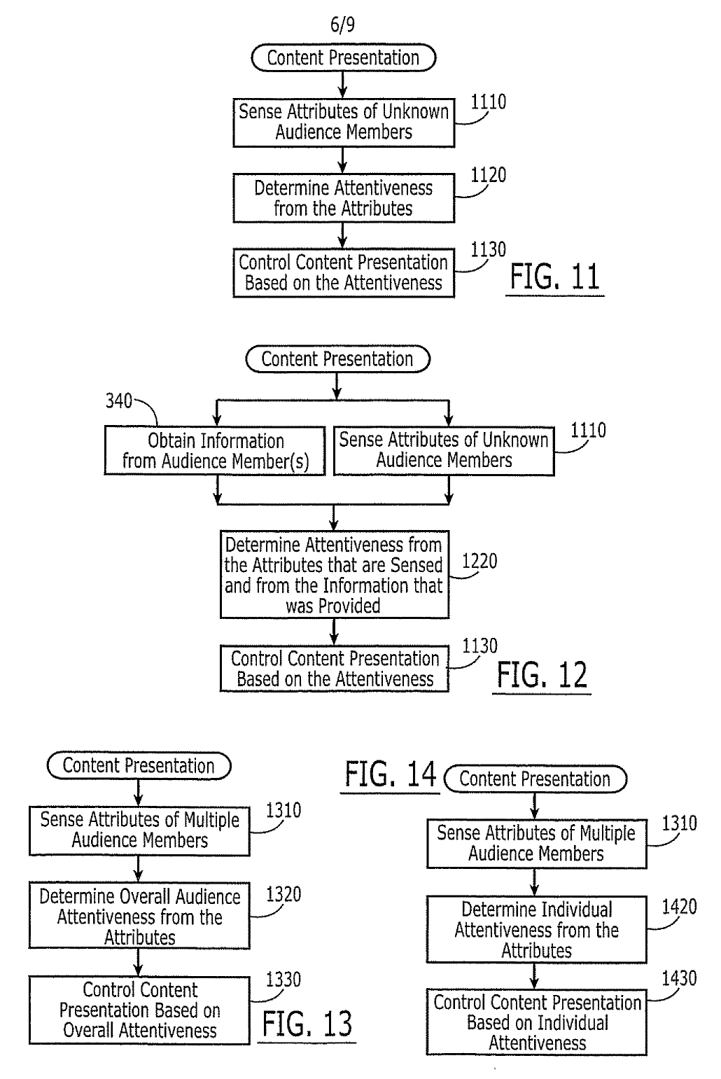

FIG. 11 is a flowchart of operations that may be performed to present content based on attentiveness according to various embodiments of the present invention. These operations may be carried out, for example, by content presentation systems, methods and/or computer program products of FIG. 1.

Referring to FIG. 11, at Block 1110, attributes of a plurality of unknown audience members are sensed. Operations at Block 1110 may performed using the sensors 150 and the sensor interface 121 of FIG. 1 to sense attributes of audience members 160. Then, at Block 1120, attentiveness of the audience members is determined from the attributes that are sensed. The attentiveness may be determined by, for example, the controller 122 of FIG. 1, and stored in the demographics database 124 of FIG. 1. Finally, at Block 1130, a content presentation device, such as the content presentation device 110 of FIG. 1, is controlled based on the attentiveness that is determined. For example, the rules database 125 may be used by the controller 122 of FIG. 1, in conjunction with the attentiveness that is stored in the demographics database 124, to control content that is presented in the content presentation device. It will also be understood by those having skill in the art that a separate attentiveness database may be provided, as may a separate attentiveness rules database.

In some embodiments of FIG. 11, the operations of sensing attributes (Block 1110), determining attentiveness (Block 1120) and controlling content presentation based on the attentiveness (Block 1130) may be performed without affirmatively identifying any of the unknown audience members. Accordingly, some embodiments of the present invention may control a content presentation device based on the attentiveness of the unknown audience members, without raising privacy issues or other similar concerns that may arise if an affirmative identification is made. Moreover, in many public or private venues, affirmative identification may be difficult or even impossible. Yet, embodiments of the present invention can provide audience-adaptive control content presentation based on attentiveness that is determined, without the need to affirmatively identify the audience members themselves.

Yet other embodiments of the invention, as illustrated in FIG. 12, may couple passive determination of attentiveness with information that is actively provided by at least one audience member. In particular, referring to FIG. 12, content is presented by obtaining information from at least one audience member, as was already described in connection with Block 340. The information provided by the at least one audience member of Block 340 may be combined with the attributes that are sensed at Block 1110, to determine attentiveness from the attributes that were sent from the information that was provided at Block 1220. The content presentation device is then controlled at Block 1130 based on the attentiveness.

The information that was provided by the at least one audience member at Block 340 may be demographic information and/or identification information, as was already described in connection with FIG. 3. A direct input of preferences or attentiveness may be provided by the at least one audience member in some embodiments. Moreover, in some embodiments, the mere fact of providing information may imply a high degree of attentiveness, so that the information that is obtained from an audience member at Block 340 may be given a different weight, such as a greater weight, than the sensed attributes at Block 1110. Thus, this active audience member's preferences and/or demographics may be given greater weight than the passive audience member.

In still other embodiments, the information that is obtained from an audience member at Block 340 and/or the passively sensed information at Block 1110, may be used to affirmatively identify an audience member, and a stored profile for the identified audience member may be used to control content, as described, for example, in copending application Ser. No. 11/465,235, to Smith et al., entitled Apparatus, Methods and Computer Program Products for Audience-Adaptive Control of Content Presentation, filed Aug. 17, 2006, assigned to the assignee of the present invention, the disclosure of which is hereby incorporated herein by reference in its entirety as if set forth fully herein. Combinations of stored profiles and attentiveness also may be used. Moreover, in still other embodiments of the present invention, stored profiles may be used for unknown audience members who exhibit a certain pattern of attentiveness over time, without the need to identify the audience member. A profile may be associated with preferences and measured attentiveness and/or other demographic characteristics and used to control the content presentation device over time without affirmatively identifying the audience member.

FIG. 13 is a flowchart of operations to present content according to other embodiments of the present invention. Referring to FIG. 13, at Block 1310, the attributes of multiple audience members and, in some embodiments, substantially all audience members, are sensed. Then, at Block 1320, an overall attentiveness of the audience is determined from the attributes that are sensed. At Block 1330, the content presentation on the content presentation device is controlled based on the overall attentiveness. In some embodiments, if a low overall attentiveness is present, the content may be changed based on the low overall attentiveness. In contrast, if a relatively high overall attentiveness is present, the current content that is being presented may be continued. For example, if a movie is being played and high overall attentiveness is being measured, the movie may continue, whereas if low overall attentiveness is present, the movie may be stopped and background music may be played. Moreover, in other embodiments, the content can be changed in response to high overall attentiveness and retained in response to low overall attentiveness in other embodiments. For example, if high attentiveness to background music is detected, then a movie may begin, whereas if low attentiveness to the background music is detected, the background music may continue.

FIG. 14 illustrates other embodiments of the present invention wherein attributes are sensed at Block 1310, and then individual attentiveness of the plurality of audience members is determined from the attributes at Block 1420. The content presentation device is controlled at Block 1430, based on the individual attentiveness of the audience members that is determined.

For example, the attentiveness of various individual audience members may be classified as being high or low, and the content presentation device may be controlled based strongly on the audience members having relatively high attentiveness and based weakly on the audience members having low attentiveness. Stated differently, the demographics and/or preferences of those audience members having relatively low attentiveness may be given little or no weight in controlling the content. In still other embodiments, the demographics of the plurality of unknown members may be weighted differently based on the individual attentiveness of the plurality of unknown audience members.

Thus, as was already described in connection with FIG. 7, one of the demographic categories may be attentiveness, and an attentiveness metric may be assigned to an individual audience member (known or unknown), and then the known preferences and/or demographic data of that individual member may be weighted in the calculation of content presentation based on attentiveness. In some embodiments, the preferences and/or demographics of audience members with low attentiveness may be ignored completely. In other embodiments, the preferences and/or demographics of audience members with low attentiveness may be weighted very highly in an attempt to refocus these audience members on the content presentation device.

In summary, high attentiveness of an individual audience member may be used to strongly influence the content in some embodiments, since these audience members are paying attention, and may be used to weakly influence the content in other embodiments, since they are already paying close attention. Conversely, audience members having low attention may be considered strongly in controlling the content, in an attempt to regain their attention, or may be considered weakly or ignored in controlling the content, because these audience members are already not paying attention.

In some embodiments, attentiveness may be determined on a scale, for example, from one to ten. Alternatively, a binary determination (attentive/not attentive) may be made. In other embodiments, attentiveness may be classified into broad categories, such as low, medium or high. In still other embodiments, three different types of attentiveness may be identified: passive, active or interactive. Passive attentiveness denotes that the user is asleep or engaging in other activities, such as conversations unrelated to the content presentation. Active attentiveness indicates that the user is awake and appears to be paying some attention to the content. Finally, interactive attentiveness denotes that the user's attributes are actively changing in response to changes in the content that is presented.

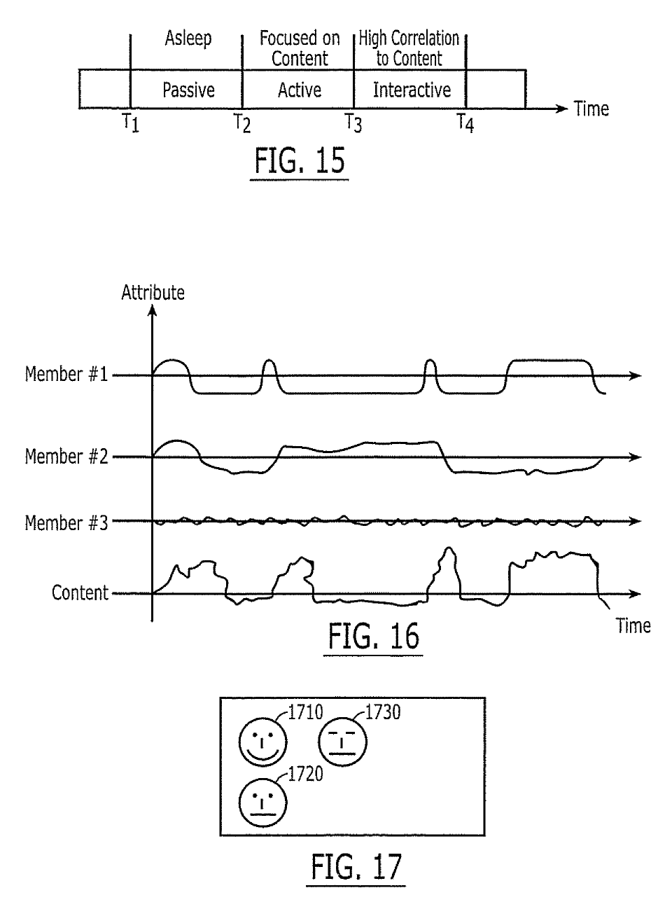

FIG. 15 graphically illustrates these three types of attentiveness over time according to some embodiments of the present invention. From time T₁ to time T₂, a user may be passive because image analysis indicates that the user's eyes are closed or the user's eyes are pointed in a direction away from the content presentation device and/or audio analysis may indicate that the user is snoring or maintaining a conversation that is unrelated to the content From time T₂ to T₃, the user may be classified as being active, because the attributes that are sensed indicate that the user is paying some attention to the content. The user's eyes may be pointed to the content presentation device, the user's motion may be minimal and/or the user may not be talking. Finally, from time T₃ to T₄, the user is in interactive attentiveness, wherein the user's eye motion, facial expression or voice may change in response to characteristics of the content. The audience member is, therefore, clearly interacting with the content. Other indications of interacting with the content may include the user activating a remote control, activating a recording device or showing other heightened attention to the content.

FIG. 15 also illustrates other embodiments of the present invention wherein the attributes that are sensed are time-stamped, and determining attentiveness may be performed over time from the time-stamped attributes that are sensed. The content presentation device may be controlled based on a current time and the attentiveness that is determined. Thus, historic attentiveness may be used to control current presentation of content, analogous to embodiments of FIG. 9. For example, if it is known that after 10 PM, an audience typically actively pays attention but does not interact with the content presentation device, because they are tired and/or intoxicated, the content may be controlled accordingly.

Thus, one technique for determining attentiveness according to some embodiments of the invention can comprise correlating or comparing the attributes that are sensed against characteristics of the content that is currently being presented, to determine attentiveness of the audience member. FIG. 16 graphically illustrates an example of this correlation according to some embodiments of the present invention.

Referring now to FIG. 16, the bottom trace illustrates one or more parameters or characteristics of the content over time. For example, if the content is a comedy show, this parameter may be the “laugh track” of the comedy show that shows times of high intensity content. Alternatively, if the content is a sporting event, the attribute may be crowd noise, which shows periods of high intensity in the game. Other attributes may be the timing of advertisements relative to the timing of the primary content.

Attributes of audience members may be correlated with attributes of the content, as shown in the first, second and third traces of FIG. 16. The attributes that are correlated may include motion of the user, audible sounds emitted from the user, retinal movement, etc. As shown in FIG. 16, the attribute(s) of Member #1 appear to correlate highly with the content, whereas the attribute(s) of Member #2 appear to correlate less closely with the content. Very little, if any, correlation appears for Member #3. From these correlations, it can be deduced that Member #1 is actually interacting with the content, whereas Member #2 may be actively paying attention, but may not be interacting with the content. Member #3's attributes appear to be totally unrelated to content, and so Member #3 may be classified as passive. Accordingly, the attributes that are sensed may be correlated against characteristics of the content that is currently being presented, to determine attentiveness of the audience member.

Once the attentiveness of a known or unknown audience member is determined, the profile of the known or unknown audience member may actually be updated based on the attentiveness that was determined. For example, if a low attentiveness was determined during a sporting event, the audience member's profile may be updated to indicate that this audience member (known or unknown) does not prefer sporting events.

Moreover, according to other embodiments of the present invention, a metric of the attentiveness that is determined may be presented on the content presentation device. For example, FIG. 17 illustrates a screen of the content presentation device, wherein three images are presented corresponding to three audience members. One image 1710 includes a smile, indicating the user is actually interacting with the content. Another image 1720 is expressionless, indicating that the user is active, but not interactive. A third image 1730 includes closed eyes, indicating that the user is asleep. Other metrics of attentiveness may be audible, including a message that says “Wake up”, or a message that says “You are not paying attention, so we have stopped the movie”, or the like. The metrics may be presented relative to known and/or unknown users. The metrics may also be stored for future use.

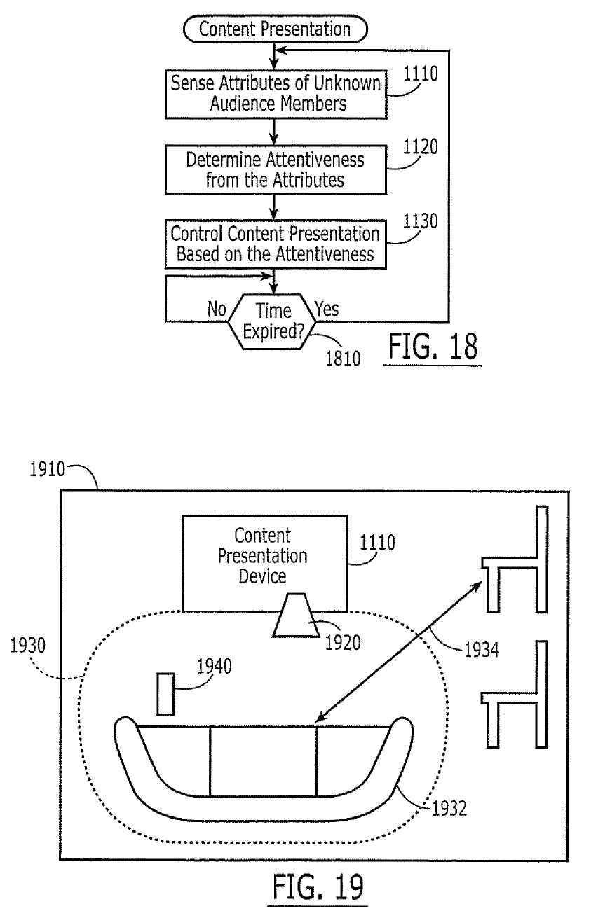

FIG. 18 illustrates other embodiments of the present invention, wherein sensing attributes, determining attentiveness and controlling the content presentation device (Blocks 1110, 1120 and 1130, respectively) are repeatedly performed at periodic and/or non-periodic time intervals that are determined, for example, by expiration of a timer, at Block 1810, Changes in the attentiveness of the audience members may be determined in response to the repeated sensing at Block 1120 and the content presentation device may be repeatedly controlled in response to the changes in the attentiveness at Block 1130. Other embodiments of the present invention may repeatedly determine attentiveness in response to changes in confidence level of the determination, analogous to embodiments of FIG. 4, and/or may repeatedly determine attentiveness in response to addition and/or loss of an audience member, analogous to embodiments of FIG. 6. These embodiments will not be described again for the sake of brevity.

As was the case for determining demographics, many different attributes of audience members may be sensed to determine attentiveness. An image of and/or sound from the audience member(s) may be sensed. This sensed information may be used to determine a facial expression, a motion pattern, a voice pattern, an eye motion pattern and/or a position relative to the content presentation device, for one or more of the audience members. Separate motion/position sensors also may be provided as was described above. Attentiveness may then be determined from the facial expression, motion pattern, voice pattern, eye motion pattern and/or position relative to the content presentation device. In particular, face recognition may be used to determine whether an audience member is looking at the content source. A retinal scan may be used to determine an interest level. User utterances may be determined by correlating a users voice and distance from the content source. Other detection techniques that may be used may include heart sensing, remote control usage, speech pattern analysis, activity/inactivity analysis, turning the equipment on or off, knock or footstep analysis, specific face and body expressions, retinal or other attributes, voice analysis and/or past activity matching.

As was described above, in some embodiments, attentiveness may be determined based on position of audience members relative to the content presentation device. For example, FIG. 19 illustrates a content presentation device 110 that includes an image sensor 1920, such as a camera, that points to a primary content consumption area 1930 that may include a sofa 1932 therein. Image analysis may assume that users that are present in the primary consumption area 1930 are paying attention. Moreover, image analysis may track movement of users into and out of the primary consumption area, as shown by arrow 1934, and may assign different levels of attentiveness in response to the detected movement. A remote control 1940 also may be included and a higher degree of attentiveness may be assigned to a user who is holding or using the remote control 1940.

Moreover, a users presence or absence in the primary consumption area 1930 may provide an autonomous login and/or logout, for attentiveness determination. Conversely, attentiveness determination may provide an autonomous login and/or logout. An autonomous login may be provided when a user moves into the primary consumption area, as shown by arrow 1934. The user may be identified or not identified. An autonomous logout may be provided by detecting that the user in the primary consumption area 1930 is sleeping, has left, is not interacting or has turned off the device 110 using the remote control 1940.

Attentiveness has been described above primarily in connection with the program content that is being presented by a content presentation device. However, attentiveness may also be measured relative to advertising content. Moreover, attentiveness among large, unknown audiences may be used by content providers to determine advertising rates/content and/or other advertising parameters. In particular, it is known to provide a measure of “eyeballs” or viewers to determine advertising rates/content and/or other parameters. However, embodiments of the invention may also provide a measure of attentiveness of an audience, which may be more important than a mere number of eyeballs in determining advertising rates/content and/or other parameters. Thus, advertising rates/content and/or other parameters may be determined by a combination of number of audience members and attentiveness of the audience members, in some embodiments of the invention.

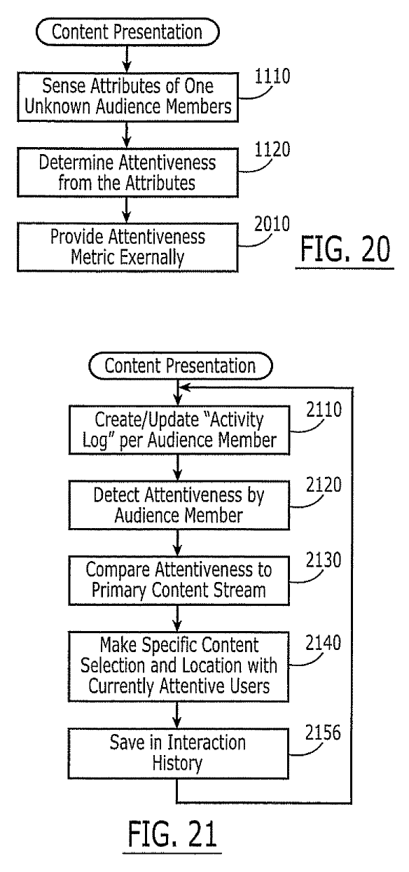

These embodiments are illustrated in FIG. 20. As shown in FIG. 20, attributes are sensed at Block 1110 and attentiveness is determined at Block 1120, as was already described above. Then, at Block 2010, an attentiveness metric is provided external of the audience. The attentiveness metric may be provided to a content provider, an advertiser and/or any other external organization. In some embodiments, the metric is provided without any other information. In other embodiments, the metric may be provided along with a count of audience members. In still other embodiments, the metric may be provided along with demographic information for the audience members. In yet other embodiments, the metric may be provided along with identification of audience members. Combinations of these embodiments also may be provided. Accordingly, attentiveness may be used in measuring effectiveness of content including advertising content.

FIG. 21 is a flowchart of specific embodiments of controlling content presentation based on audience member attentiveness according to some embodiments of the present invention. Referring to FIG. 21, at Block 2110, an activity log is created or updated for each audience member. The audience member may be an identified (known) audience member or may be an unknown audience member, wherein an activity log may be created using an alias, as described in the above-cited application Ser. No. 11/465,235. Then, at Block 2120, attentiveness is detected for each audience member using, for example, techniques that were described above. The attentiveness may be compared to the primary content stream at Block 2130 to obtain a correlation, as was described above. At Block 2140, the specific content selection and the present location may be marked with the currently attentive users, and the identification of the specific content with the attentive users may be saved in an interaction history at Block 2156. The interaction history may be used to control content presentation, in the present time and/or at a future time, and/or provided to content providers including advertising providers. The interaction history at Block 2156 may also be used to adjust individual and group “best picks” for content as the audience changes.

It will be understood by those having skill in the art that the embodiments of the invention related to attentiveness that were described in FIGS. 11-21 may be combined in various combinations and subcombinations. Moreover, the attentiveness embodiments of FIGS. 11-21 may be combined with the demographic embodiments of FIGS. 1-10 in various combinations and subcombinations.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method of presenting content, the method comprising:
sensing attributes of a plurality of unknown audience members;
determining demographics of the plurality of unknown audience members from the attributes that are sensed; and
controlling a content presentation device based on the demographics that are determined.

2. A method according to claim 1 wherein sensing attributes is repeatedly performed, wherein determining demographics of the plurality of unknown audience members is repeatedly performed with increasing levels of confidence in response to the repeated sensing and wherein controlling a content presentation device is repeatedly performed in response to the increasing levels of confidence.

3. A method according to claim 1 wherein sensing attributes is repeatedly performed, wherein determining demographics comprises determining changes in the demographics of the plurality of unknown audience members in response to the repeated sensing and wherein controlling a content presentation device is repeatedly performed in response to the changes in the demographics.

4. A method according to claim 1 further comprising detecting addition or loss of at least one of the unknown audience members and wherein sensing attributes, determining demographics and controlling a content presentation device are again performed in response to detecting the addition or loss.

5. A method according to claim 1 further comprising determining demographics of at least one audience member in response to information provided by the at least one audience member and wherein controlling a content presentation device is performed in response to the demographics that were determined by sensing attributes and from the information provided by the at least one audience member.

6. A method according to claim 5 wherein the information provided by the at least one audience member comprises demographic information for the at least one audience member and/or an identification of the at least one audience member.

7. A method according to claim 5 wherein controlling the content presentation device is performed by assigning different weight to the information provided by the at least one audience member than to the demographics that are determined.

8. A method according to claim 1 wherein sensing attributes is performed by multiple sensors of same and/or different types.

9. A method according to claim 8 wherein the multiple sensors comprise at least one image sensor, audio sensor and/or olfactory sensor and wherein the corresponding attributes comprise an image, sound and/or smell of the plurality of unknown audience members.

10. A method according to claim 1 wherein the demographics comprise gender, age, nationality, language, physical activity, attentiveness and/or intoxication demographics of the plurality of audience members.

11. A method according to claim 1 wherein sensing attributes comprises sensing an image of the audience members, wherein determining demographics comprises determining a predominant gender and a predominant nationality of the audience members from the image and wherein controlling a content presentation device comprises controlling the content presentation device to present content that is directed to the predominant gender and the predominant nationality, and in a language of the predominant nationality.

12. A method according to claim 1 wherein sensing attributes comprises sensing sound from the audience members, wherein determining demographics comprises determining a predominant gender and/or a predominant nationality of the audience members from the sound and wherein controlling a content presentation device comprises controlling the content presentation device to present content that is directed to the predominant gender and the predominant nationality, and in a language of the predominant nationality.

13. A method according to claim 1 wherein sensing attributes comprises sensing motion of the audience members, wherein determining demographics comprises determining an activity level of the audience from the motion and wherein controlling a content presentation device comprises controlling the content presentation device to present content that is directed to the activity level of the audience.

14. A method according to claim 1 wherein sensing attributes, determining demographics and controlling a content presentation device are performed without affirmatively identifying the unknown audience members.

15. A method according to claim 1 wherein controlling a content presentation device based on the demographics that were determined comprises controlling a type of content presented on the content presentation device, a language of the content, a version of the content, a sound volume of the content and/or advertising content based on the demographics that are determined.

16. A method according to claim 1 wherein sensing attributes comprises time-stamping the attributes that are sensed, wherein determining demographics comprises determining demographics of the plurality of unknown audience members over time from the time-stamped attributes that are sensed and wherein controlling a content presentation device comprises controlling the content presentation device based on a current time and the demographics that are determined.

17. A content presentation system comprising:
a content presentation device configured to provide an audio and/or visual output; and
an audience-adaptive controller configured to sense attributes of a plurality of unknown audience members, determine demographics of the plurality of unknown audience members from the attributes that are sensed and control the content presentation device based on the demographics that are determined.

18. A system according to claim 17 wherein the attributes comprise an image, sound and/or smell of the plurality of unknown audience members and wherein the demographics comprise gender, age, nationality, language, physical activity, attentiveness and/or intoxication demographics of the plurality of audience members.

19. A computer program product for presenting content, the computer program product comprising a computer usable storage medium having computer-readable program code embodied in the medium, the computer-readable program code comprising:
computer-readable program code configured to sense attributes of a plurality of unknown audience members;
computer-readable program code configured to determine demographics of the plurality of unknown audience members from attributes that are sensed; and
computer-readable program code configured to control a content presentation device based on the demographics that are determined.

20. A computer program product according to claim 19 wherein the attributes comprise an image, sound and/or smell of the plurality of unknown audience members and wherein the demographics comprise gender, age, nationality, language, physical activity, attentiveness and/or intoxication demographics of the plurality of audience members.
